(19) United States
(12) Patent Application Publication
(10) Pub. No.: US 2023/0342606 A1
(43) Pub. Date: Oct. 26, 2023

(54) TRAINING METHOD AND APPARATUS FOR GRAPH NEURAL NETWORK

(71) Applicants: Alipay (Hangzhou) Information Technology Co., Ltd., Hangzhou (CN); Beijing University of Posts and Telecommunications, Beijing (CN)

(72) Inventors: Binbin HU, Hangzhou (CN); Liu HONGRUI, Beijing (CN); Zhiqiang ZHANG, Hangzhou (CN); Shi CHUAN, Beijing (CN); Xiao WANG, Beijing (CN); Jun ZHOU, Hangzhou (CN)

(21) Appl. No.: 18/306,144

(22) Filed: Apr. 24, 2023

(30) Foreign Application Priority Data
Apr. 25, 2022 (CN) 202210440602.3

(51) Int. Cl. G06N 3/08

(52) U.S. Cl. CPC G06N 3/08

(57) ABSTRACT

Implementations of the present specification provide a training method for a graph neural network, and relate to performing multiple rounds of iterative updating on a graph neural network based on a user relational graph, where any round of the multiple rounds includes: processing the user relational graph by using a current graph neural network, to obtain multiple classification prediction vectors corresponding to multiple user nodes in the user relational graph; allocating a corresponding pseudo classification label to a first quantity of unlabeled nodes in the multiple user nodes based on the multiple classification prediction vectors; determining, for each of the first quantity of unlabeled nodes, an information gain generated by training the current graph neural network by using the unlabeled node; and updating a model parameter in the current graph neural network according to a classification prediction vector and a real classification label that are corresponding to each labeled node in the multiple user nodes, and a classification prediction vector, a pseudo classification label, and an information gain that are corresponding to each unlabeled node.

### TECHNICAL FIELD

One or more implementations of the present specification relate to the field of machine learning technologies, and in particular, to graph neural network.

### BACKGROUND

A relational network graph is a description of a relationship between entities in the real world, and is currently widely used in various service processing, for example, social network analysis and chemical bond prediction. A graph neural network (GNN) is applicable to various tasks on a relational network graph. However, performance of the GNN largely depends on a quantity of labeled data, and generally, the performance of the GNN rapidly decreases as labeled data decreases.

### SUMMARY

The present specification provides a technical solution that breaks through a limitation of insufficient labeled data during GNN training, and obtains a GNN model with excellent performance, which effectively improves accuracy of a service processing result.

One or more implementations of the present specification describe a training method and apparatus for a graph neural network. Labeled data is expanded by using unlabeled data, and an information gain is introduced to reduce the difference between a training loss corresponding to distribution of original labeled data and a training loss corresponding to distribution of expanded labeled data, which improves a training effect of a GNN model.

According to a first aspect, a training method for a graph neural network is provided, and relates to performing multiple rounds of iterative updating on a graph neural network based on a user relational graph, where any round of the multiple rounds includes: processing the user relational graph by using a current graph neural network, to obtain multiple classification prediction vectors corresponding to multiple user nodes in the user relational graph; allocating a corresponding pseudo classification label to a first quantity of unlabeled nodes in the multiple user nodes based on the multiple classification prediction vectors; determining, for each of the first quantity of unlabeled nodes, an information gain generated by training the current graph neural network by using the unlabeled node; and updating a model parameter in the current graph neural network according to a classification prediction vector and a real classification label that are corresponding to each labeled node in the multiple user nodes, and a classification prediction vector, a pseudo classification label, and an information gain that are corresponding to each unlabeled node.

In an example implementation, the multiple user nodes comprise a second quantity of unlabeled nodes, and classification prediction vectors comprise multiple prediction probabilities corresponding to multiple categories; where the allocating the corresponding pseudo classification label to the first quantity of unlabeled nodes in the multiple user nodes based on the multiple classification prediction vectors includes: for each node in the second quantity of unlabeled nodes, in response to that a maximum prediction probability included in a classification prediction vector corresponding to the node reaches a predetermined threshold, classifying the node into the first quantity of unlabeled nodes, and determining a category corresponding to the maximum prediction probability as a pseudo classification label of the node.

In an example implementation, the determining, for each of the first quantity of unlabeled nodes, the information gain generated by training the current graph neural network by using the unlabeled node includes: for a first unlabeled node of the first quantity of unlabeled nodes, training the current graph neural network by using a first classification prediction vector and a pseudo classification label that are corresponding to the first unlabeled node, and determining a second classification prediction vector of the first unlabeled node based on a trained first graph neural network; determining first information entropy according to the first classification prediction vector; determining second information entropy according to the second classification prediction vector; and obtaining the information gain based on a difference between the second information entropy and the first information entropy.

In an example implementation, the trained first graph neural network comprises multiple aggregation layers and an output layer; and the determining the second classification prediction vector of the first unlabeled node based on the trained first graph neural network includes: performing, at an aggregation layer in the multiple aggregation layers, random zeroing processing on vector elements in multiple aggregation vectors for the multiple user nodes that are output by an upper aggregation layer, and determining, based on the multiple aggregation vectors after the random zeroing processing, multiple aggregation vectors that are output by the aggregation layer for the multiple user nodes; and processing, at the output layer, an aggregation vector output by a last aggregation layer for the first unlabeled user node, to obtain the second classification prediction vector.

In an example implementation, the trained first graph neural network comprises multiple aggregation layers and an output layer; and the determining the second classification prediction vector of the first unlabeled node based on the trained first graph neural network includes: performing, at an aggregation layer in the multiple aggregation layers, random zeroing processing on a matrix element in an adjacency matrix corresponding to the user relational graph, and determining, based on the adjacency matrix after the random zeroing processing and multiple aggregation vectors that are output by an upper aggregation layer for the multiple user nodes, multiple aggregation vectors for the multiple user nodes that are output by the aggregation layer; and processing, at the output layer, an aggregation vector output by a last aggregation layer for the first unlabeled user node, to obtain the second classification prediction vector.

Further, in a further example implementation, the determining the second classification prediction vector of the unlabeled node based on the trained first graph neural network includes: performing for multiple times an operation of determining the second classification prediction vector to correspondingly obtain multiple second classification prediction vectors; where the determining the second information entropy according to the second classification prediction vector includes: determining an average value of multiple pieces of information entropy respectively corresponding to the multiple second classification prediction vectors as the second information entropy.

In an example implementation, the updating the model parameter in the current graph neural network according to the classification prediction vector and the real classification label that are corresponding to each labeled node in the multiple user nodes, and the classification prediction vector, the pseudo classification label, and the information gain that are corresponding to each unlabeled node includes: determining a first loss term according to the classification prediction vector and the real classification label that are corresponding to each labeled node; determining a second loss term for each unlabeled node according to the classification prediction vector and the pseudo classification label that are corresponding to each unlabeled node, and weighting the second loss term by using the information gain corresponding to the unlabeled node; and updating the model parameter according to the first loss term and the weighted second loss term.

In an example implementation, the weighting the second loss term by using the information gain corresponding to the unlabeled node includes: normalizing the information gain of each unlabeled node by using a first quantity of information gains corresponding to the first quantity of unlabeled nodes, to obtain a corresponding weighting coefficient; and performing weighting processing by using the weighting coefficient.

According to a second aspect, a training method for a graph neural network is provided, and relates to performing multiple rounds iterative updating on a graph neural network based on a pre-constructed relational graph, where any round of the multiple rounds includes: processing the relational graph by using a current graph neural network, to obtain multiple classification prediction vectors corresponding to multiple service object nodes in the relational graph; allocating a corresponding pseudo classification label to a first quantity of unlabeled nodes in the multiple service object nodes based on the multiple classification prediction vectors; determining, for each of the first quantity of unlabeled nodes, an information gain generated by training the current graph neural network by using the unlabeled node; and updating a model parameter in the current graph neural network according to a classification prediction vector and a real classification label that are corresponding to each labeled node in the multiple service object nodes, and a classification prediction vector, a pseudo classification label, and an information gain that are corresponding to each unlabeled node.

According to a third aspect, a training apparatus for a graph neural network is provided, where the apparatus performs, by using following units, any one of multiple rounds of iterative updating on a graph neural network according to a user relational graph: a classification prediction unit, configured to process the user relational graph by using a current graph neural network, to obtain multiple classification prediction vectors corresponding to multiple user nodes in the user relational graph; a pseudo label allocation unit, configured to allocate a corresponding pseudo classification label to a first quantity of unlabeled nodes in the multiple user nodes based on the multiple classification prediction vectors; an information gain determining unit, configured to determine, for each of the first quantity of unlabeled nodes, an information gain generated by training the current graph neural network by using the unlabeled node; and a parameter updating unit, configured to update a model parameter in the current graph neural network according to a classification prediction vector and a real classification label that are corresponding to each labeled node in the multiple user nodes, and a classification prediction vector, a pseudo classification label, and an information gain that are corresponding to each unlabeled node.

According to a fourth aspect, a training apparatus for a graph neural network is provided, where the apparatus performs, by using following units, any one of multiple rounds of iterative updating on a graph neural network according to a pre-constructed relational graph: a classification prediction unit, configured to process the relational graph by using a current graph neural network, to obtain multiple classification prediction vectors corresponding to multiple service object nodes in the relational graph; a pseudo label allocation unit, configured to allocate a corresponding pseudo classification label to a first quantity of unlabeled nodes in the multiple service object nodes based on the multiple classification prediction vectors; an information gain determining unit, configured to determine, for each of the first quantity of unlabeled nodes, an information gain generated by training the current graph neural network by using the unlabeled node; and a parameter updating unit, configured to update a model parameter in the current graph neural network according to a classification prediction vector and a real classification label that are corresponding to each labeled node in the multiple service object nodes, and a classification prediction vector, a pseudo classification label, and an information gain that are corresponding to each unlabeled node.

According to a fifth aspect, a computer readable storage medium that stores a computer program is provided, and when the computer program is executed on a computer, the computer is caused to perform the methods according to the first aspect or the second aspect.

According to a sixth aspect, a computing device is provided, including a memory and a processor, where the memory stores executable code, and when the processor executes the executable code, the methods according to the first aspect or the second aspect are implemented.

According to the method and the apparatus provided in the implementations of the present specification, labeled data is expanded by using unlabeled data in a user relational graph, and an information gain is introduced to reduce the difference between a training loss corresponding to distribution of original labeled data and a training loss corresponding to distribution of expanded labeled data, so as to effectively improve a training effect of a GNN model, and further improve prediction accuracy of a trained GNN model on a user node.

### BRIEF DESCRIPTION OF DRAWINGS

To describe the technical solutions in the implementations of the present disclosure more clearly, the following briefly introduces the accompanying drawings required for describing the implementations. Clearly, the accompanying drawings in the following description are merely some implementations of the present disclosure, and a person of ordinary skill in the field can still derive other drawings from these accompanying drawings without creative efforts.

FIG. 1 is a schematic diagram of a training framework of a graph neural network according to an implementation;

FIG. 2 is a schematic flowchart of a training method for a graph neural network according to an implementation;

FIG. 3 is a flowchart of a method for determining an information gain according to an implementation;

FIG. 4 is a schematic flowchart of a training method for a graph neural network according to another implementation;

FIG. 5 is a schematic structural diagram of a training apparatus for a graph neural network according to an implementation; and

FIG. 6 is a schematic structural diagram of a training apparatus for a graph neural network according to another implementation.

### DESCRIPTION OF IMPLEMENTATIONS

The solutions provided in the present specification are described below with reference to the accompanying drawings.

As described above, the specification provides a solution that can break through a limitation of labeled data shortage during GNN training. The solution includes a way of self-training that solves, among others, the problem of scarcity of labeled data by making full use of abundant unlabeled data. For example, a model trained on an original labeled data set [symbol] _{L} is given as a teacher model, and prediction is performed on an unlabeled data set [symbol] _{U}. Then, a pseudo label is marked on a corresponding unlabeled data subset [symbol] _{U} by using a prediction result with high confidence, so as to expand the original labeled data. Then, a student model is trained by using an expanded labeled data set [symbol] _{L}∪ [symbol] _{U}, and the teacher model is updated by using the trained student model. As such, iterations are repeated until the student model converges.

A key of the above self-training method is that pseudo labeling is performed on an unlabeled sample with high confidence, so as to expand labeled data. However, the inventor found through experiments and analysis that, compared with the original labeled data set [symbol] _{L}, the expanded labeled data set [symbol] _{L}∪ [symbol] _{U} obtained after expansion by using the unlabeled sample with high confidence undergoes distribution shift, which results in poor performance of a GNN model trained by using the expanded data set [symbol] _{L}∪ [symbol] _{U}, and it is difficult to obtain a decision boundary that is sufficiently clear and robust. Further, analysis is performed from the perspective of a loss function, data distribution obeyed by the original labeled data set [symbol] _{L} is denoted as Pₚₒₚ, and a classifier f_{θ} whose parameter is denoted as θ is given. Therefore, optimal setting of a model parameter θ can be obtained by minimizing the loss function represented by the following equation (1).

[symbol]

ₚₒₚ= [symbol] ₍ᵥ_{ᵢ}_{,y}_{ᵢ}_{)˜P}_{ₚₒₚ}₍ [symbol] ₎l(yᵢ,pᵢ) (1)

In the above equation (1), vᵢ and yᵢ respectively represent a node feature and a node label of an ith labeled node that obeys Pₚₒₚ distribution; pᵢ represents a prediction result output by the classifier fa for the ith labeled node; and l(·,·) represents multiple classification losses, for example, can be cross entropy losses.

Similarly, for the above self-training scenario in which distribution shift exists, the following loss function can be used to calculate a training loss:

$${ℒ}_{st} = \frac{\vert {𝒱}_{L} \vert}{\vert {𝒱}_{L} ⋃ {𝒮}_{U} \vert} {𝔼}_{( {v}_{i} , {y}_{i} ) \sim {P}_{pop} ( 𝓋 , 𝓎 )} l ( {y}_{i} , {p}_{i} ) + \frac{\vert {𝒮}_{U} \vert}{\vert {𝒱}_{L} ⋃ {𝒮}_{U} \vert} {𝔼}_{( {v}_{u} , {y}_{u} ) \sim {P}_{st} ( 𝓋 , 𝓎 )} l ( {\overline{y}}_{u} , {p}_{u} ) \qquad ( 2 )$$

In the above equation (2), vᵤ and yᵤ respectively represent a node feature and a real node label (not actually obtained) of a uth unlabeled node that obeys Pₛₜ distribution; y̅ᵤ indicates a pseudo label of the uth unlabeled node; and pᵤ indicates a prediction result output by the classifier f_{θ} for the uth unlabeled node.

By performing comparative analysis on the above equations (1) and (2), it can be understood that distribution shift in the self-training process severely affects training performance of a graph model, and further causes deterioration of generalization performance of the graph model in a prediction phase. Therefore, it is more ideal to optimize the classifier f_{θ} by using the training loss calculated by using the equation (1) than by using the equation (2). However, in practice, because labeled data is scarce, it is difficult to accurately restore real labeled data distribution, and only Lₛₜ calculated in equation (2) is available. Some implementations of the specification apply the following theorem, which reduce or eliminate the gap between Lₛₜ and Lₚₒₚ:

Given the losses Lₚₒₚ and Lₛₜ respectively defined in equations (1) and (2), assume that for each node vᵤ in a pseudo-labeled data set [symbol] _{U}, y̅ᵤ=yᵤ. Then Lₛₜ=Lₚₒₚ is valid. When Lₛₜ can be denoted as having an additional weight coefficient

$${γ}_{u} = \frac{{P}_{pop} ( {v}_{u} , {y}_{u} )}{{P}_{st} ( {v}_{u} , {y}_{u} )}$$

as follows:

$${ℒ}_{st} = \frac{\vert {𝒮}_{U} \vert}{\vert {𝒱}_{L} ⋃ {𝒮}_{U} \vert} {𝔼}_{( {v}_{u} , {y}_{u} ) \sim {P}_{st} ( 𝓋 , 𝓎 ) {γ}_{u}} l ( {\overline{y}}_{u} , {p}_{u} ) + \frac{\vert {𝒱}_{L} \vert}{\vert {𝒱}_{L} ⋃ {𝒮}_{U} \vert} {𝔼}_{( {v}_{i} , {y}_{i} ) \sim {P}_{pop} ( 𝓋 , 𝓎 )} l ( {y}_{i} , {p}_{i} ) , \qquad ( 3 )$$

the process of proof of the above theorem is as follows:

First, according to the assumption for the node vᵤ: y̅ᵤ=yᵤ, equation (1) can be rewritten in the following form:

$${ℒ}_{pop} = \frac{\vert {𝒮}_{U} \vert}{\vert {𝒱}_{L} ⋃ {𝒮}_{U} \vert} {𝔼}_{( {v}_{u} , {y}_{u} ) \sim {P}_{pop} ( 𝓋 , 𝓎 )} l ( {\overline{y}}_{u} , {p}_{u} ) + \frac{\vert {𝒱}_{L} \vert}{\vert {𝒱}_{L} ⋃ {𝒮}_{U} \vert} {𝔼}_{( {v}_{i} , {y}_{i} ) \sim {P}_{pop} ( 𝓋 , 𝓎 )} l ( {y}_{i} , {p}_{i} ) \qquad ( 4 )$$

It is noticed that:

$${𝔼}_{( {v}_{u} , {y}_{u} ) \sim {P}_{pop} ( 𝓋 , 𝓎 )} l ( {\overline{y}}_{u} , {p}_{u} ) = {𝔼}_{( {v}_{u} , {y}_{u} ) \sim {P}_{st} ( 𝓋 , 𝓎 )} \frac{{P}_{pop} ( {v}_{u} , {y}_{u} )}{{P}_{st} ( {v}_{u} , {y}_{u} )} l ( {\overline{y}}_{u} , {p}_{u} ) \qquad ( 5 )$$

Therefore, equation (4) can be rewritten as follows:

$${ℒ}_{pop} = \frac{\vert {𝒮}_{U} \vert}{\vert {𝒱}_{L} ⋃ {𝒮}_{U} \vert} {𝔼}_{( {v}_{u} , {y}_{u} ) \sim {P}_{st} ( 𝓋 , 𝓎 )} \frac{{P}_{pop} ( {v}_{u} , {y}_{u} )}{{P}_{st} ( {v}_{u} , {y}_{u} )} l ( {\overline{y}}_{u} , {p}_{u} ) + \frac{\vert {𝒱}_{U} \vert}{\vert {𝒱}_{L} ⋃ {𝒮}_{U} \vert} {𝔼}_{( {v}_{i} , {y}_{i} ) \sim {P}_{pop} ( 𝓋 , 𝓎 )} l ( {y}_{i} , {p}_{i} ) = \frac{\vert {𝒮}_{U} \vert}{\vert {𝒱}_{L} ⋃ {𝒮}_{U} \vert} {𝔼}_{( {v}_{u} , {y}_{u} ) \sim {P}_{st} ( 𝓋 , 𝓎 ) {γ}_{u}} l ( {\overline{y}}_{u} , {p}_{u} ) + \frac{\vert {𝒱}_{L} \vert}{\vert {𝒱}_{L} ⋃ {𝒮}_{U} \vert} {𝔼}_{( {v}_{i} , {y}_{i} ) \sim {P}_{pop} ( 𝓋 , 𝓎 )} l ( {y}_{i} , {p}_{i} ) \qquad ( 6 )$$

γᵤ can be considered as the weight of the loss function l(y̅ᵤ, pᵤ) of the unlabeled node vᵤ.

Finally, recalling the loss function in the distribution shift case shown in equation (2), it can be found that, Lₛₜ in equation (2) can be denoted as a form of adding an additional weight coefficient γᵤ to equation (1). In other words, as long as an appropriate coefficient γᵤ can be added for each pseudo-labeled node in Lₛₜ, Lₛₜ can approximate Lₚₒₚ.

However, because the labeled data distribution Pₚₒₚ is usually difficult to solve, this means that the weight coefficient γᵤ is difficult to solve accurately. Further, the inventor found, by using a means such as visualization, that the weight coefficient γᵤ and an information gain [symbol] ᵤ that are corresponding to the unlabeled node vᵤ have the same change trend. For example, farther from the decision boundary, smaller values of the two. In some implementations, the weight coefficient γᵤ is approximated by solving the information gain [symbol] ᵤ. Simply, the information gain [symbol] ᵤ is measurement of the contribution of the unlabeled node vᵤ to model optimization.

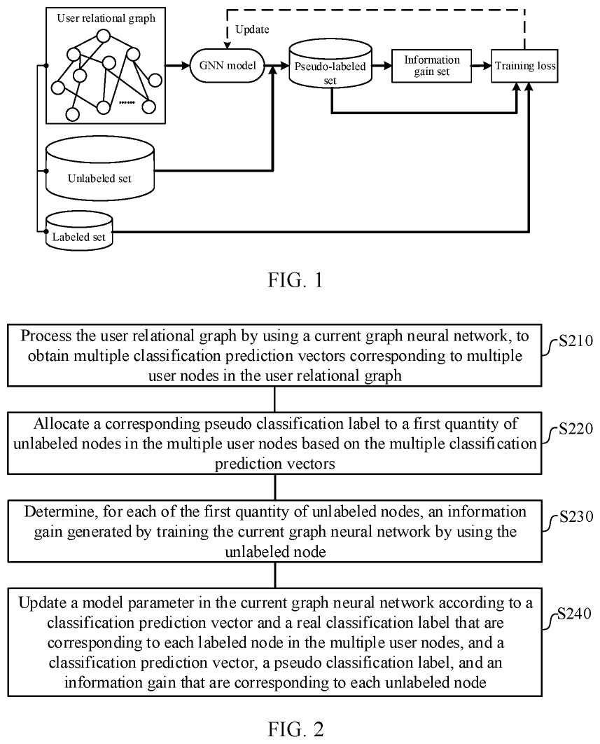

In some implementations, an implementation of weighting is conducted, by introducing the information gain [symbol] ᵤ, a loss term l(y̅ᵤ, Pu) that is in the self-training loss Lₛₜ and that is for the unlabeled node vᵤ, so Lₛₜ approximates or equals Lₚₒₚ. For ease of intuitive understanding, FIG. 1 is a schematic diagram of a training framework of a graph neural network according to an implementation; as shown in FIG. 1, graph data of a user relational network graph includes an original labeled sample set [symbol] _{L} and an unlabeled sample set [symbol] _{U}. Based on this, in graph neural network iterative training of any round, a current GNN model is first used to process the relational network graph to obtain a classification result and confidence of each unlabeled node in the unlabeled sample set [symbol] _{U}. An unlabeled node whose confidence is sufficiently high is selected and added to the unlabeled sample subset [symbol] _{U}, an information gain of each unlabeled node vᵤ therein is determined, and then a training loss is determined by using the labeled sample set [symbol] _{L}, the unlabeled sample subset [symbol] _{U}, and the correspondingly determined information gain, so as to update the GNN model.

With reference to more implementations, the following describes steps for implementing example implementations of the technical solutions. FIG. 2 is a schematic flowchart of a training method for a neural network according to an implementation. The method can be performed by any apparatus, platform, or device cluster that has a calculation and processing capability.

The training method shown in FIG. 2 involves performing multiple rounds of iterative updating on a graph neural network based on a user relational graph (or referred to as a user relational network graph). For ease of understanding, the user relational graph is first described.

The user relational graph includes multiple user nodes corresponding to multiple users, and a connection edge formed by having an association relationship between the user nodes. A node feature of the user node can include a static feature (or a basic attribute feature) and a behavior feature of a corresponding user. In an implementation, the user static feature can include a user's gender, age, occupation, usual place of residence, interest, etc. In an implementation, the user behavior feature can include a consumption frequency, a consumption amount, a consumption period, a consumption category, graphic content published on a social networking site, social activity, etc.

The multiple user nodes include a small quantity of labeled nodes that carry a user category label, and a large quantity of unlabeled nodes that do not carry a label. Generally, the label carried in the labeled node is obtained by manually marking at high labor costs. The user category label is adapted to a specific prediction task. In one implementation, the prediction task is user risk assessment. Correspondingly, the user category label can include a risky user and a risk-free user, or include a high-risk user, a low-risk user, and a medium-risk user, or include a defaulting user and a trustworthy user, or include a fraudulent user and a secure user. In an implementation, the prediction task is to divide consumption populations, and correspondingly, the user category label can include a high consumption population and a low consumption population.

The user relational graph is described above. As shown in FIG. 2, iterative updating of any one of the above multiple rounds of iterative updating includes the following steps:

Step S210: Process the user relational graph by using a current graph neural network, to obtain multiple classification prediction vectors corresponding to multiple user nodes in the user relational graph. Step S220: Allocate a corresponding pseudo classification label to a first quantity of unlabeled nodes in the multiple user nodes based on the multiple classification prediction vectors. Step S230: Determine, for each of the first quantity of unlabeled nodes, an information gain generated by training the current graph neural network by using the unlabeled node. Step S240: Update a model parameter in the current graph neural network according to a classification prediction vector and a real classification label that are corresponding to each labeled node in the multiple user nodes, and a classification prediction vector, a pseudo classification label, and an information gain that are corresponding to each unlabeled node.

The above steps are described in detail as follows:

First, in step S210, process the user relational graph by using a current graph neural network, to obtain multiple classification prediction vectors corresponding to multiple user nodes in the user relational graph. In an implementation, this round of iteration is the first round. Correspondingly, the current graph neural network can be a graph neural network obtained after parameter initialization setting is performed, or can be a graph neural network obtained after a graph neural network obtained after parameter initialization is trained by using multiple labeled nodes and labels carried by the multiple labeled nodes. In an implementation, the current round of iteration is not the first round, and correspondingly, the current graph neural network can be a graph neural network obtained after updating by the previous round of iteration.

The current graph neural network includes multiple aggregation layers and an output layer, and the multiple aggregation layers are used to perform graph embedding processing on the user relational graph to obtain multiple node embedding vectors corresponding to the multiple user nodes. It should be understood that an input to the first aggregation layer in the multiple aggregation layers includes an original feature of a user node and/or a connection edge, and the multiple aggregation layers perform high-order representation of the node based on the original feature, so as to obtain a node representation vector (or referred to as a node embedding vector) with deep semantics. Further, the output layer is used to output a classification prediction result of a corresponding user node according to each node embedding vector.

In an implementation, the type of the current graph neural network is a graph convolutional neural network (GCN). Correspondingly, an output H^{(l)} of any an lth aggregation layer in the GCN can be calculated by using the following equation:

H^{(l)}=σ( [symbol] (A)H^{(l-1)}W^{(l)}) (7)

In the above equation (7), A represents an adjacency matrix of the user relational graph, and is used to record a connection relationship between user nodes. For example, for any element Aᵢⱼ in the adjacency matrix A, when the value of the element is 1 or 0, respectively representing that a connection edge exists or does not exist between a user node i and a user node j. [symbol] (·) represents a normalization operator; W^{(l)} represents a parameter matrix at the lth aggregation layer, and W^{(l)}∈ [symbol] ^{D}^{ₗ₋₁}^{×D}^{ₗ}. H^{(l-1)} represents an output of an ((l−1))th aggregation layer. It should be understood that, H⁽⁰⁾=X∈ [symbol] , where X represents a feature matrix formed by node features of the multiple user nodes, [symbol] represents a node set formed by the multiple user nodes, | [symbol] | represents a quantity of nodes in the node set, and [symbol] represents a dimension of the node feature. In addition, H^{(l)}∈ [symbol] a parameter of a GCN model θ={W^{(l)}}ₗ₌₁^{L}, and L is a total quantity of the multiple aggregation layers.

In an implementation, the type of the current graph neural network can be a graph attention network (GAT), etc. It should be understood that there are a variety of existing types of graph neural networks, and the type can be selected as required in the implementations disclosed in the present specification, which is not specifically limited.

In an aspect, the output layer includes one or more fully connected network sublayers. By using the fully connected network sublayer, linear transformation and/or nonlinear transformation processing can be separately performed on each node embedding vector, so as to obtain a classification prediction vector of a corresponding user node, where multiple vector elements in the classification prediction vector are corresponding to multiple category probabilities.

Therefore, multiple classification prediction vectors corresponding to multiple user nodes can be obtained. Then, in step S220, allocate a corresponding pseudo classification label to a first quantity of unlabeled nodes in the multiple user nodes based on the multiple classification prediction vectors.

For description purposes, a quantity of all unlabeled nodes in the multiple user nodes is recorded as a second quantity. For example, in this step, a corresponding pseudo classification label can be allocated to some or all of the unlabeled nodes based on classification prediction vectors corresponding to the second quantity of unlabeled nodes.

In an implementation, for each node in the second quantity of unlabeled nodes, a category corresponding to the maximum prediction probability in a classification prediction vector corresponding to the node is determined as a pseudo classification label of the node. As such, a corresponding pseudo classification label can be allocated to the second quantity of unlabeled nodes. In this case, the first quantity is equal to the second quantity.

In an implementation, for each node in the second quantity of unlabeled nodes, in response to that a maximum prediction probability included in a classification prediction vector corresponding to the node reaches a predetermined threshold, the node is classified into the first quantity of unlabeled nodes, and a category corresponding to the maximum prediction probability is determined as a pseudo classification label of the node. In an example implementation, the predetermined threshold is that the maximum prediction probability is greater than a predetermined threshold (for example, 0.2). In an example implementation, the predetermined threshold is as follows: The maximum prediction probability corresponding to the node is top k ranked (for example, k=1000) in a second quantity of maximum prediction probabilities. As such, it can be implemented that an unlabeled node with high confidence (the confidence is equal to the maximum prediction probability) is selected from a full quantity of unlabeled nodes, and a pseudo label is marked for the unlabeled node. In this case, the first quantity is less than the second quantity.

The above can implement automatic marking on the first quantity of unlabeled nodes. For clarity of description, in this implementation of the present specification, an unlabeled subset formed by the first quantity of unlabeled nodes is denoted as [symbol] _{U}.

Then, in step S230, determine, for each of the first quantity of unlabeled nodes, an information gain generated by training the current graph neural network by using the unlabeled node. It should be understood that, in probability theory or information theory, the information gain refers to a reduction in an amount of information about a random event after a specific variable value (for example, cloudy) is assigned to a random variable (for example, tomorrow's weather) in the random event (for example, whether it rains tomorrow). The information amount is usually obtained by calculating Shannon's entropy or called information entropy. According to the definition of the information gain, for any unlabeled node vᵤ in the unlabeled subset [symbol] _{U}, the information gain [symbol] ᵤ on the GNN model parameter θ can be calculated by using predictive distribution and a posterior parameter P(θ| [symbol] ). For details, refer to the following equation:

[symbol]

ᵤ( [symbol] ᵤ,θ|xᵤ,A, [symbol] )= [symbol] [ [symbol] _{P(θ|} [symbol] ₎[ [symbol] ᵤ|xᵤ,A;θ]]− [symbol] _{P(θ|} [symbol] ₎[H[ [symbol] ᵤ|xᵤ,A;θ]] (8)

In the above equation (8), the first term on the right is an expected value of information entropy of predictive distribution Pᵤ(yᵤ|xᵤ, A, [symbol] ) under the posterior parameter P(θ| [symbol] ), which is used to measure an information amount when a model parameter θ is not changed, [symbol] represents the above user relational graph, and yᵤ represents a category probability vector output by the GNN model f_{θ}. The second term is an average value (or expected value) of conditional entropy under a given node feature xᵤ, and is used to capture an information amount of the model parameter θ after the model f_{θ} is optimized by using a node vᵤ. As such, the information gain brought by the unlabeled node vᵤ to the model parameter θ can be measured by calculating the difference between the two terms.

It can be observed from equation (8) that if the information gain [symbol] ᵤ is calculated by using equation (8), the posteriori parameter P(θ| [symbol] ) needs to be calculated. However, the posteriori parameter P(θ| [symbol] ) is usually difficult to solve. In a possible method, the posteriori parameter P(θ| [symbol] ) can be calculated by using a conventional Bayesian network, but this causes huge calculation consumption.

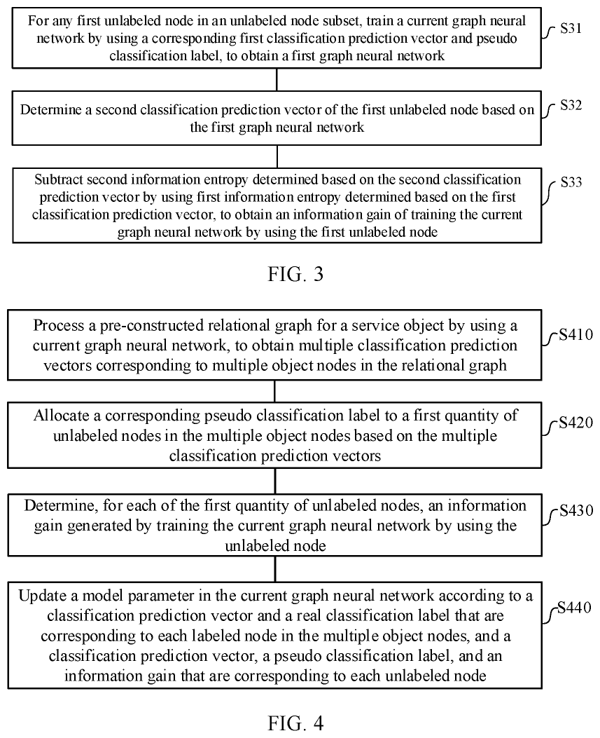

Therefore, in an example method, a relatively accurate information gain calculation value can be obtained by using a small quantity of calculation. For example, a dropout or dropedge algorithm is used to implement approximation of the posteriori parameter P(θ| [symbol] ). With reference to FIG. 3, the following describes a method of determining the information gain based on the dropout algorithm or the dropedge algorithm. As shown in FIG. 3, the method includes the following steps:

Step S31: For any unlabeled node vᵤ (or referred to as a first unlabeled node) in an unlabeled node subset [symbol] _{U}, train a current graph neural network by using a first classification prediction vector corresponding to the first unlabeled node in the multiple classification prediction vectors and a pseudo classification label corresponding to the first unlabeled node, to obtain a first graph neural network. For example, a training loss is calculated by using the first classification prediction vector and the corresponding pseudo classification label, and then a parameter in the current graph neural network is optimized (or referred to as updated) by using the training loss, to obtain an updated first graph neural network.

Step S32: Determine a second classification prediction vector of the unlabeled node vᵤ based on the trained first graph neural network.

In an implementation, a dropout algorithm is introduced to perform random masking (or random zeroing) on a user node feature. For example, at an aggregation layer in multiple aggregation layers included in the first graph neural network, random zeroing processing is performed on vector elements in multiple aggregation vectors for the multiple user nodes that are output by an upper aggregation layer, and multiple aggregation vectors that are output by the current aggregation layer for the multiple user nodes are determined based on the multiple aggregation vectors after the random zeroing processing.

In an example implementation, the aggregation layer can be pre-specified or randomly set by a worker. For example, the last aggregation layer in the multiple aggregation layers can be specified to perform a dropout operation. In an example implementation, it is not limited to one aggregation layer for performing zeroing processing on the vector element, and there can be another quantity. For example, a dropout operation of a node feature can be performed on each aggregation layer.

In an aspect, in an example implementation, when the current graph neural network is a GCN, a process of processing, at the above aggregation layer based on the dropout algorithm, multiple aggregation vectors output at the upper layer to obtain an output at the current layer can be denoted as the following equation:

H^{(l)}=σ( [symbol] (A)(H^{(l-1)}⊙Z^{(l)})W^{(l)}) (9)

In the above equation (9), H^{(l-1)} represents a matrix formed by multiple aggregation vectors output at the upper layer; Z^{(l)}∈{0,1}^{D}^{ₗ₋₁}^{×D}^{ₗ}, where Dₗ₋₁×Dₗ matrix elements can be obtained by performing multiple times of sampling from Bernoulli distribution, and each matrix element indicates whether to set a matrix element at a corresponding location in the matrix H^{(l-1)} to zero; and the operator ⊙ represents multiplication of elements at the same location between two matrices.

Further, at the output layer, processing is performed on the aggregation vector H^{(L)} output by the last aggregation layer for the unlabeled node vᵤ, to obtain the second classification prediction vector \tilde{p}ᵤ=\tilde{p}(yᵤ|xᵤ, A; \tilde{θ}). Or average processing can be performed on multiple aggregation vectors {H^{(l)}}₁^{L} output by multiple aggregation layers for the unlabeled node vᵤ, to obtain the second classification prediction vector \tilde{p}ᵤ.

It is noted that the operation term H^{(l-1)}⊙Z^{(l-1)} in equation (9) implements Bernoulli sampling on a node feature, which is equivalent to sampling in parameter distribution to which the posterior parameter P(θ| [symbol] ) conforms. Therefore, to estimate the posterior parameter P(θ| [symbol] ), the above prediction operation can be performed multiple times to perform sampling on the parameter distribution multiple times (denoted as T times), and correspondingly, a corresponding second classification prediction vector \tilde{p}ᵤ^{t}=\tilde{p}^{t}(yᵤ|xᵤ, A; \tilde{θ}ₜ) is obtained each time (denoted as a tth time). As such, T second classification prediction vectors {\tilde{p}ᵤ^{t}}ₜ₌₁^{T} can be obtained based on the dropout algorithm.

In an implementation, a dropedge algorithm is introduced to randomly mask a connection edge between user nodes. For example, at an aggregation layer in the multiple aggregation layers included in the first graph neural network, random zeroing processing is performed on a matrix element in an adjacency matrix A corresponding to the user relational graph, and multiple aggregation vectors for the multiple user nodes that are output by the aggregation layer are determined based on the adjacency matrix after the random zeroing processing and multiple aggregation vectors that are output by an upper aggregation layer for the multiple user nodes.

In an example implementation, the above aggregation layer can be pre-specified or randomly set by a worker. In practice, the above aggregation layer can be specified as the last aggregation layer in the multiple aggregation layers. In an example implementation, it is not limited to one aggregation layer for performing zeroing processing on the element of the adjacency matrix, and there can be another quantity. For example, a dropedge operation of an edge feature can be performed on each aggregation layer.

In an aspect, in an example implementation, when the current graph neural network is a GCN, a process of processing, at the above aggregation layer based on the dropedge algorithm, multiple aggregation vectors output at the upper layer to obtain an output at the current layer can be denoted as the following equation:

H^{(l)}=σ( [symbol] (A⊙Z^{(l)})(H^{(l-1)})W^{(l)}) (10)

In the above equation (10), H^{(l-1)} represents a matrix formed by multiple aggregation vectors output at the upper layer; Z^{(l)}∈{0,1 [symbol] , where | [symbol] |×| [symbol] | matrix elements can be obtained by performing multiple times of sampling from Bernoulli distribution, and each matrix element indicates whether to set a matrix element at a corresponding location in the adjacency matrix A to zero.

Further, at the output layer, processing is performed on the aggregation vector H^{(L)} output by the last aggregation layer for the unlabeled node vᵤ, to obtain the second classification prediction vector \tilde{p}ᵤ=\tilde{p}(yᵤ|xᵤ, A; \tilde{θ}). Or average processing can be performed on multiple aggregation vectors {H(l)}₁^{L} output by multiple aggregation layers for the unlabeled node vᵤ, to obtain the second classification prediction vector \tilde{p}ᵤ.

It is noted that the operation term A⊙Z^{(l)} in equation (10) implements Bernoulli sampling on a connection edge, which is equivalent to sampling in parameter distribution to which the posterior parameter P(θ| [symbol] ) conforms. Therefore, to estimate the posterior parameter P(θ| [symbol] ), the above prediction operation can be performed multiple times to perform sampling on the parameter distribution multiple times (denoted as T times), and correspondingly, a corresponding second classification prediction vector \tilde{p}ᵤ^{t}=\tilde{p}^{t}(yᵤ|xᵤ, A; \tilde{θ}^{t}) is obtained each time (denoted as a tth time). As such, T second classification prediction vectors {\tilde{p}ᵤ^{t}}ₜ₌₁^{T} can be obtained based on the dropedge algorithm.

Therefore, T second classification prediction vectors {\tilde{p}ᵤ^{t}}ₜ₌₁^{T} can be obtained based on the dropout algorithm or the dropedge algorithm.

Step S33: Subtract second information entropy determined based on the second classification prediction vector by using first information entropy determined based on the first classification prediction vector, to obtain an information gain of training the current graph neural network by using the first unlabeled node.

In an implementation, the obtained T second classification prediction vectors {\tilde{p}ᵤ^{t}}ₜ₌₁^{T} can be averaged to obtain an expectation for a prediction vector of the unlabeled node vᵤ:

$${p}_{u}^{𝒢} = p ( {y}_{u} \vert {x}_{u} , A , 𝒢 ) = \frac{1}{T} {\sum }_{t = 1}^{T} {\tilde{p}}_{u}^{t} , {\tilde{θ}}_{t} \sim P ( θ \vert 𝒢 ) \qquad ( 11 )$$

Therefore, the information gain [symbol] ᵤ corresponding to the unlabeled node vᵤ can be calculated by using the following equation:

$${𝔹}_{u} ( {y}_{u} , θ \vert {x}_{u} , A , 𝒢 ) = - {\sum }_{d = 1}^{D} {p}_{u , d}^{𝒢} log {p}_{u , d}^{𝒢} + \frac{1}{T} {\sum }_{d = 1}^{D} {\sum }_{t = 1}^{T} {\tilde{p}}_{u , d}^{t} log {\tilde{p}}_{u , d}^{t} \qquad ( 12 )$$

In the above equation (12), the first term on the right represents the first information entropy, and the reverse number of the second term represents the second information entropy. For example, D represents a dimension of the classification prediction vector, that is, a total quantity of categories; [symbol] represents a prediction probability corresponding to a dth category in the first classification prediction vector; and \tilde{p}_{u,d}^{t} represents a prediction probability corresponding to the dth category in the tth second classification prediction vector.

Therefore, the information gain [symbol] ᵤ brought by the unlabeled node vᵤ to the model parameter can be determined based on the dropout algorithm or the dropedge algorithm.

In addition, it is not preferable that in an implementation, in step S32, the dropout or dropedge algorithm may not be introduced, but the user relational graph is directly processed by using a parameter that is in the first graph neural network and that is not zeroed, to obtain the second classification prediction vector of the unlabeled node vᵤ, so as to calculate the second information entropy according to the second classification prediction vector. In an implementation, in step S32, parameter sampling times T in equation (12) can also be 1.

Therefore, an information gain [symbol] ᵤ that can be brought by each unlabeled node vᵤ in the unlabeled subset [symbol] _{U} to the current GNN model parameter can be determined.

Then, in step S240, a model parameter in the current graph neural network is updated according to a classification prediction vector and a real classification label that are corresponding to each labeled node in the multiple user nodes, and a classification prediction vector, a pseudo classification label, and an information gain that are corresponding to each unlabeled node.

For example, on one hand, a first loss term is determined according to the classification prediction vector and the real classification label that are corresponding to each labeled node. On the other hand, for each unlabeled node, a second loss term is determined according to the classification prediction vector and the pseudo classification label that are corresponding to the node, and weighted processing is performed on the second loss term by using the information gain corresponding to the node. Further, a comprehensive loss is determined according to the first loss term and the weighted second loss term, so as to update the model parameter in the current graph neural network according to the comprehensive loss.

In an implementation, the weighting processing includes: normalizing the information gain of each unlabeled node by using a first quantity of information gains corresponding to the first quantity of unlabeled nodes, to obtain a corresponding weighting coefficient; and performing weighting processing on the second loss term by using the weighting coefficient.

According to an example, the above comprehensive loss can be calculated by using the following equation:

$${ℒ}_{st} = \frac{\vert {𝒮}_{U} \vert}{\vert {𝒱}_{L} ⋃ {𝒮}_{U} \vert} {𝔼}_{( {v}_{u} , {y}_{u} ) \sim {P}_{st} ( 𝓋 , 𝓎 )} {\overline{𝔹}}_{u} l ( {\overline{y}}_{u} , {p}_{u} ) + \frac{\vert {𝒱}_{L} \vert}{\vert {𝒱}_{L} ⋃ {𝒮}_{U} \vert} {𝔼}_{( {v}_{i} , {y}_{i} ) \sim {P}_{pop} ( 𝓋 , 𝓎 )} l ( {y}_{i} , {p}_{i} ) \qquad ( 13 )$$

$${\overline{𝔹}}_{u} = \frac{{𝔹}_{u}}{β \cdot \frac{1}{\vert {𝒮}_{U} \vert} {\sum }_{i} {𝔹}_{i}}$$

In equation (13), [symbol] ᵢ represents an information gain of an ith node in an unlabeled subset [symbol] _{U}. As such, the weight coefficient γᵤ of equation (3) can be approximated by using the normalized result [symbol] ᵤ of the information gain [symbol] ᵤ, so as to obtain Lₛₜ of an approximation loss Lₚₒₚ.

Further, a training gradient can be calculated by using the determined comprehensive loss, and then the model parameter in the current graph neural network model is updated by using a back propagation method according to the training gradient.

In conclusion, according to the training method for a graph neural network disclosed in this implementation of the present specification, labeled data is expanded by using unlabeled data in a user relational graph, and an information gain is introduced to reduce the difference between a training loss corresponding to distribution of original labeled data and a training loss corresponding to distribution of expanded labeled data, so as to effectively improve a training effect of a GNN model, and further improve prediction accuracy of a trained GNN model on a user node.

The above describes the training method for a graph neural network used to process a user relational network graph. Actually, the above method can be further extended to training a graph neural network that is associated with a relational network graph of another service object. FIG. 4 is a schematic flowchart of a training method for a neural network according to an implementation. The method can be performed by any apparatus, server, or device cluster that has a calculation and processing capability.

The training method shown in FIG. 2 involves performing multiple rounds of iterative updating on a graph neural network based on a relational graph, where the relational graph includes multiple object nodes corresponding to multiple service objects, and a connection edge formed by an association relationship existing between the object nodes. In an implementation, the multiple service objects are multiple products. Further, a feature of a product node can include: category, origin, cost, selling price, etc. A label involved in the product node can be a product popularity level, for example, a high-popularity product or a low-popularity product. In an implementation, the multiple service objects are multiple papers. Further, a feature of a paper node can include paper name, keyword, abstract, etc., and a label involved in the paper node can be a field to which the paper belongs, for example, biology, chemistry, physics, and a computer.

As shown in FIG. 4, the method includes the following steps:

Step S410: Process the relational graph by using a current graph neural network, to obtain multiple classification prediction vectors corresponding to multiple service object nodes in the relational graph. Step S420: Allocate a corresponding pseudo classification label to a first quantity of unlabeled nodes in the multiple service object nodes based on the multiple classification prediction vectors. Step S430: Determine, for each of the first quantity of unlabeled nodes, an information gain generated by training the current graph neural network by using the unlabeled node. Step S440: Update a model parameter in the current graph neural network according to a classification prediction vector and a real classification label that are corresponding to each labeled node in the multiple service object nodes, and a classification prediction vector, a pseudo classification label, and an information gain that are corresponding to each unlabeled node.

It should be noted that for description of the method steps shown in FIG. 4, refer to the description of the method steps shown in FIG. 2 in the above implementation. Details are omitted herein for simplicity.

In conclusion, according to the training method for a graph neural network disclosed in this implementation of the present specification, labeled data is expanded by using unlabeled data in a relational graph, and an information gain is introduced to reduce the difference between a training loss corresponding to distribution of original labeled data and a training loss corresponding to distribution of expanded labeled data, so as to effectively improve a training effect of a GNN model, and further improve prediction accuracy of a trained GNN model on a service object node.

Corresponding to the above training method, an implementation of the present specification further discloses a training apparatus. FIG. 5 is a schematic structural diagram of a training apparatus for a graph neural network according to an implementation. The apparatus 500 performs, by using following units, any one of multiple rounds of iterative updating on a graph neural network according to a user relational graph:

a classification prediction unit 510, configured to process the user relational graph by using a current graph neural network, to obtain multiple classification prediction vectors corresponding to multiple user nodes in the user relational graph; a pseudo label allocation unit 520, configured to allocate a corresponding pseudo classification label to a first quantity of unlabeled nodes in the multiple user nodes based on the multiple classification prediction vectors; an information gain determining unit 530, configured to determine, for each of the first quantity of unlabeled nodes, an information gain generated by training the current graph neural network by using the unlabeled node; and a parameter updating unit 540, configured to update a model parameter in the current graph neural network according to a classification prediction vector and a real classification label that are corresponding to each labeled node in the multiple user nodes, and a classification prediction vector, a pseudo classification label, and an information gain that are corresponding to each unlabeled node.

In an implementation, the multiple user nodes comprise a second quantity of unlabeled nodes, and classification prediction vectors comprise multiple prediction probabilities corresponding to multiple categories; and the pseudo label allocation unit 520 is, in some implementations, configured to: for each node in the second quantity of unlabeled nodes, in response to that a maximum prediction probability included in a classification prediction vector corresponding to the node reaches a predetermined threshold, classify the node into the first quantity of unlabeled nodes, and determine a category corresponding to the maximum prediction probability as a pseudo classification label of the node.

In an implementation, the information gain determining unit 530 includes: a training subunit 531, configured to: for a first unlabeled node of the first quantity of unlabeled nodes, train the current graph neural network by using a first classification prediction vector and a pseudo classification label that are corresponding to the first unlabeled node; a prediction subunit 532, configured to determine a second classification prediction vector of the first unlabeled node based on a trained first graph neural network; an information entropy determining subunit 533, configured to determine first information entropy according to the first classification prediction vector, and determine second information entropy according to the second classification prediction vector; and a gain determining subunit 534, configured to obtain the information gain based on a difference between the second information entropy and the first information entropy.

Further, in an example implementation, the trained first graph neural network includes multiple aggregation layers and an output layer. The prediction subunit 532 is, for example, configured to: perform, at an aggregation layer in the multiple aggregation layers, random zeroing processing on vector elements in multiple aggregation vectors for the multiple user nodes that are output by an upper aggregation layer, and determine, based on the multiple aggregation vectors after the random zeroing processing, multiple aggregation vectors that are output by the aggregation layer for the multiple user nodes; and process, at the output layer, an aggregation vector output by a last aggregation layer for the first unlabeled user node, to obtain the second classification prediction vector.

In an example implementation, the trained first graph neural network includes multiple aggregation layers and an output layer. The prediction subunit 532 is, in some implementations, configured to: perform, at an aggregation layer in the multiple aggregation layers, random zeroing processing on a matrix element in an adjacency matrix corresponding to the user relational graph, and determine, based on the adjacency matrix after the random zeroing processing and multiple aggregation vectors that are output by an upper aggregation layer for the multiple user nodes, multiple aggregation vectors for the multiple user nodes that are output by the aggregation layer; and process, at the output layer, an aggregation vector output by a last aggregation layer for the first unlabeled user node, to obtain the second classification prediction vector.

Further, in a further example implementation, the prediction subunit 532 is further configured to: perform an operation of determining the second classification prediction vector for multiple times, and correspondingly obtain multiple second classification prediction vectors. The information entropy determining subunit 533 is, for example, configured to determine an average value of multiple pieces of information entropy respectively corresponding to the multiple second classification prediction vectors as the second information entropy.

In an implementation, the parameter updating unit 540 is configured to determine a first loss term according to the classification prediction vector and the real classification label that are corresponding to each labeled node; determine a second loss term for each unlabeled node according to the classification prediction vector and the pseudo classification label that are corresponding to each unlabeled node, and weight the second loss term by using the information gain corresponding to the unlabeled node; and update the model parameter according to the first loss term and the weighted second loss term.

In an example implementation, that the parameter updating unit 540 is configured to perform the above weighting processing includes: normalizing the information gain of each unlabeled node by using a first quantity of information gains corresponding to the first quantity of unlabeled nodes, to obtain a corresponding weighting coefficient; and performing weighting processing by using the weighting coefficient.

In conclusion, according to the training apparatus for a graph neural network disclosed in this implementation of the present specification, labeled data is expanded by using unlabeled data in a user relational graph, and an information gain is introduced to reduce the difference between a training loss corresponding to distribution of original labeled data and a training loss corresponding to distribution of expanded labeled data, so as to effectively improve a training effect of a GNN model, and further improve prediction accuracy of a trained GNN model on a user node.

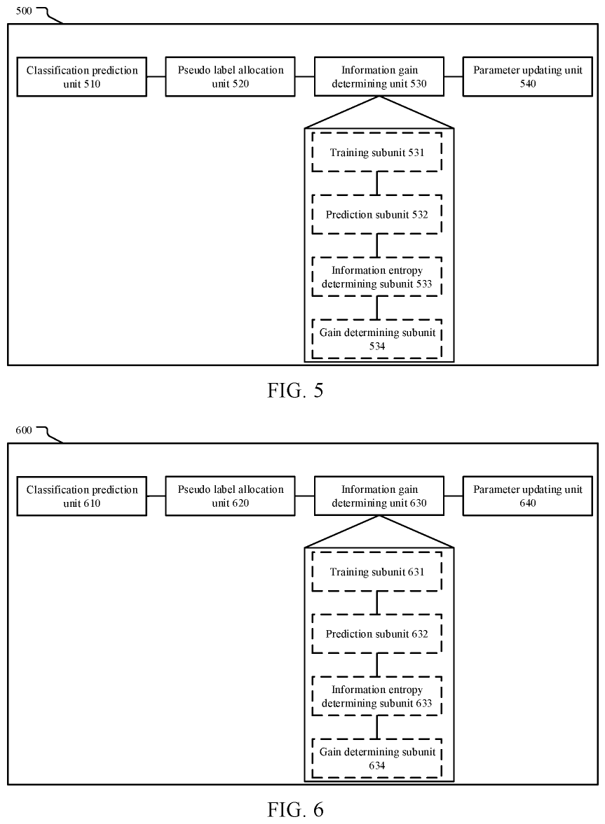

FIG. 6 is a schematic structural diagram of a training apparatus for a graph neural network according to an implementation. As shown in FIG. 6, the apparatus 600 performs, by using following units, any one of multiple rounds of iterative updating on a graph neural network according to a pre-constructed relational graph: a classification prediction unit 610, configured to process the relational graph by using a current graph neural network, to obtain multiple classification prediction vectors corresponding to multiple service object nodes in the relational graph; a pseudo label allocation unit 620, configured to allocate a corresponding pseudo classification label to a first quantity of unlabeled nodes in the multiple service object nodes based on the multiple classification prediction vectors; an information gain determining unit 630, configured to determine, for each of the first quantity of unlabeled nodes, an information gain generated by training the current graph neural network by using the unlabeled node; and a parameter updating unit 640, configured to update a model parameter in the current graph neural network according to a classification prediction vector and a real classification label that are corresponding to each labeled node in the multiple service object nodes, and a classification prediction vector, a pseudo classification label, and an information gain that are corresponding to each unlabeled node.

In an implementation, the multiple service object nodes comprise a second quantity of unlabeled nodes, and classification prediction vectors comprise multiple prediction probabilities corresponding to multiple categories; and the pseudo label allocation unit 620 is, in some implementations, configured to: for each node in the second quantity of unlabeled nodes, in response to that a maximum prediction probability included in a classification prediction vector corresponding to the node reaches a predetermined threshold, classify the node into the first quantity of unlabeled nodes, and determine a category corresponding to the maximum prediction probability as a pseudo classification label of the node.

In an implementation, the information gain determining unit 630 includes: a training subunit 631, configured to: for a first unlabeled node of the first quantity of unlabeled nodes, train the current graph neural network by using a first classification prediction vector and a pseudo classification label that are corresponding to the first unlabeled node; a prediction subunit 632, configured to determine a second classification prediction vector of the first unlabeled node based on a trained first graph neural network; an information entropy determining subunit 633, configured to determine first information entropy according to the first classification prediction vector, and determine second information entropy according to the second classification prediction vector; and a gain determining subunit 634, configured to obtain the information gain based on a difference between the second information entropy and the first information entropy.

Further, in an example implementation, the trained first graph neural network includes multiple aggregation layers and an output layer. The prediction subunit 632 is, for example, configured to: perform, at an aggregation layer in the multiple aggregation layers, random zeroing processing on vector elements in multiple aggregation vectors for the multiple service object nodes that are output by an upper aggregation layer, and determine, based on the multiple aggregation vectors after the random zeroing processing, multiple aggregation vectors that are output by the aggregation layer for the multiple service object nodes; and process, at the output layer, an aggregation vector output by a last aggregation layer for the first unlabeled service object node, to obtain the second classification prediction vector.

In an example implementation, the trained first graph neural network includes multiple aggregation layers and an output layer. The prediction subunit 632 is, for example, configured to: perform, at an aggregation layer in the multiple aggregation layers, random zeroing processing on a matrix element in an adjacency matrix corresponding to the service object relational graph, and determine, based on the adjacency matrix after the random zeroing processing and multiple aggregation vectors that are output by an upper aggregation layer for the multiple service object nodes, multiple aggregation vectors for the multiple service object nodes that are output by the aggregation layer; and process, at the output layer, an aggregation vector output by a last aggregation layer for the first unlabeled service object node, to obtain the second classification prediction vector.

Further, in a further example implementation, the prediction subunit 632 is further configured to: perform an operation of determining the second classification prediction vector for multiple times, and correspondingly obtain multiple second classification prediction vectors. The information entropy determining subunit 633 is, in some implementations, configured to determine an average value of multiple pieces of information entropy respectively corresponding to the multiple second classification prediction vectors as the second information entropy.

In an implementation, the parameter updating unit 640 is configured to determine a first loss term according to the classification prediction vector and the real classification label that are corresponding to each labeled node; determine a second loss term for each unlabeled node according to the classification prediction vector and the pseudo classification label that are corresponding to each unlabeled node, and weight the second loss term by using the information gain corresponding to the unlabeled node; and update the model parameter according to the first loss term and the weighted second loss term.

In an example implementation, that the parameter updating unit 640 is configured to perform the above weighting processing includes: normalizing the information gain of each unlabeled node by using a first quantity of information gains corresponding to the first quantity of unlabeled nodes, to obtain a corresponding weighting coefficient; and performing weighting processing by using the weighting coefficient.

In conclusion, according to the training apparatus for a graph neural network disclosed in this implementation of the present specification, labeled data is expanded by using unlabeled data in a service object relational graph, and an information gain is introduced to reduce the difference between a training loss corresponding to distribution of original labeled data and a training loss corresponding to distribution of expanded labeled data, so as to effectively improve a training effect of a GNN model, and further improve prediction accuracy of a trained GNN model on a service object node.

According to an implementation of an aspect, a computer readable storage medium on which a computer program is stored is further provided. When the computer program is executed in a computer, the computer is caused to perform the method described with reference to FIG. 2 or FIG. 3.

According to an implementation of still another aspect, a computing device is further provided and includes a memory and a processor. Executable code is stored in the memory, and when executing the executable code, the processor implements the method described with reference to FIG. 2 or FIG. 3. A person skilled in the art should be aware that, in one or more of the above examples, the functions described in the present specification can be implemented by using hardware, software, firmware, or any combination thereof. When these functions are implemented by software, they can be stored in a computer readable medium or transmitted as one or more instructions or code lines on the computer readable medium.

The example implementations mentioned above further describe the object, technical solutions and beneficial effects of the present disclosure. It should be understood that the above descriptions are merely example implementations of the present disclosure and are not intended to limit the protection scope of the present disclosure. Any modification, equivalent replacement and improvement made based on the technical solution of the present disclosure shall fall within the protection scope of the present disclosure.

What is claimed is:

1. A method for training a graph neural network, comprising:
performing multiple rounds of updating on a graph neural network based on a relational graph, a round of the multiple rounds including:
processing the relational graph by using a current graph neural network, to obtain multiple classification prediction vectors corresponding to multiple nodes in the relational graph;
allocating a corresponding pseudo classification label to a first quantity of unlabeled nodes in the multiple nodes based on the multiple classification prediction vectors;
determining, for each of the first quantity of unlabeled nodes, an information gain generated by training the current graph neural network by using the unlabeled node; and
updating a model parameter in the current graph neural network according to a classification prediction vector and a real classification label that are corresponding to each labeled node in the multiple nodes, and a classification prediction vector, a pseudo classification label, and an information gain that are corresponding to each unlabeled node.

2. The method according to claim 1, wherein the multiple nodes comprise a second quantity of unlabeled nodes, and classification prediction vectors comprise multiple prediction probabilities corresponding to multiple categories;
wherein the allocating the corresponding pseudo classification label to the first quantity of unlabeled nodes in the multiple nodes based on the multiple classification prediction vectors includes:
for each node in the second quantity of unlabeled nodes, in response to that a maximum prediction probability included in a classification prediction vector corresponding to the node reaches a threshold, classifying the node into the first quantity of unlabeled nodes, and determining a category corresponding to the maximum prediction probability as a pseudo classification label of the node.

3. The method according to claim 1, wherein the determining, for each of the first quantity of unlabeled nodes, the information gain generated by training the current graph neural network by using the unlabeled node includes:
for a first unlabeled node of the first quantity of unlabeled nodes,
training the current graph neural network by using a first classification prediction vector and a pseudo classification label that are corresponding to the first unlabeled node, and determining a second classification prediction vector of the first unlabeled node based on a trained first graph neural network;
determining first information entropy according to the first classification prediction vector;
determining second information entropy according to the second classification prediction vector; and
obtaining the information gain based on a difference between the second information entropy and the first information entropy.

4. The method according to claim 3, wherein the trained first graph neural network comprises multiple aggregation layers and an output layer; and the determining the second classification prediction vector of the first unlabeled node based on the trained first graph neural network includes:
performing, at an aggregation layer in the multiple aggregation layers, random zeroing processing on vector elements in multiple aggregation vectors for the multiple nodes that are output by an upper aggregation layer, and determining, based on the multiple aggregation vectors after the random zeroing processing, multiple aggregation vectors that are output by the aggregation layer for the multiple nodes; and
processing, at the output layer, an aggregation vector output by a last aggregation layer for the first unlabeled node, to obtain the second classification prediction vector.

5. The method according to claim 3, wherein the trained first graph neural network comprises multiple aggregation layers and an output layer; and the determining the second classification prediction vector of the first unlabeled node based on the trained first graph neural network includes:
performing, at an aggregation layer in the multiple aggregation layers, random zeroing processing on a matrix element in an adjacency matrix corresponding to the relational graph, and determining, based on the adjacency matrix after the random zeroing processing and multiple aggregation vectors that are output by an upper aggregation layer for the multiple nodes, multiple aggregation vectors for the multiple nodes that are output by the aggregation layer; and
processing, at the output layer, an aggregation vector output by a last aggregation layer for the first unlabeled node, to obtain the second classification prediction vector.

6. The method according to claim 4, wherein the determining the second classification prediction vector of the unlabeled node based on the trained first graph neural network includes:
performing for multiple times an operation of determining the second classification prediction vector to correspondingly obtain multiple second classification prediction vectors;
wherein the determining the second information entropy according to the second classification prediction vector includes:
determining an average value of multiple pieces of information entropy respectively corresponding to the multiple second classification prediction vectors as the second information entropy.

7. The method according to claim 1, wherein the updating the model parameter in the current graph neural network according to the classification prediction vector and the real classification label that are corresponding to each labeled node in the multiple nodes, and the classification prediction vector, the pseudo classification label, and the information gain that are corresponding to each unlabeled node includes:
determining a first loss term according to the classification prediction vector and the real classification label that are corresponding to each labeled node;
determining a second loss term for each unlabeled node according to the classification prediction vector and the pseudo classification label that are corresponding to each unlabeled node, and weighting the second loss term by using the information gain corresponding to the unlabeled node; and
updating the model parameter according to the first loss term and the weighted second loss term.

8. The method according to claim 7, wherein the weighting the second loss term by using the information gain corresponding to the unlabeled node includes:
normalizing the information gain of each unlabeled node by using a first quantity of information gains corresponding to the first quantity of unlabeled nodes, to obtain a corresponding weighting coefficient; and
performing weighting processing by using the weighting coefficient.

9. A computing system, comprising at least one memory and at least one processor, the at least one memory storing executable instructions, which when executed by the at least one processor enable the at least one processor to implement actions including:
performing multiple rounds of updating on a graph neural network based on a relational graph, a round of the multiple rounds including:
processing the relational graph by using a current graph neural network, to obtain multiple classification prediction vectors corresponding to multiple nodes in the relational graph;
allocating a corresponding pseudo classification label to a first quantity of unlabeled nodes in the multiple nodes based on the multiple classification prediction vectors;
determining, for each of the first quantity of unlabeled nodes, an information gain generated by training the current graph neural network by using the unlabeled node; and
updating a model parameter in the current graph neural network according to a classification prediction vector and a real classification label that are corresponding to each labeled node in the multiple nodes, and a classification prediction vector, a pseudo classification label, and an information gain that are corresponding to each unlabeled node.

10. The computing system according to claim 9, wherein the multiple nodes comprise a second quantity of unlabeled nodes, and classification prediction vectors comprise multiple prediction probabilities corresponding to multiple categories;
wherein the allocating the corresponding pseudo classification label to the first quantity of unlabeled nodes in the multiple nodes based on the multiple classification prediction vectors includes:
for each node in the second quantity of unlabeled nodes, in response to that a maximum prediction probability included in a classification prediction vector corresponding to the node reaches a threshold, classifying the node into the first quantity of unlabeled nodes, and determining a category corresponding to the maximum prediction probability as a pseudo classification label of the node.

11. The computing system according to claim 9, wherein the determining, for each of the first quantity of unlabeled nodes, the information gain generated by training the current graph neural network by using the unlabeled node includes:
for a first unlabeled node of the first quantity of unlabeled nodes,
training the current graph neural network by using a first classification prediction vector and a pseudo classification label that are corresponding to the first unlabeled node, and determining a second classification prediction vector of the first unlabeled node based on a trained first graph neural network;
determining first information entropy according to the first classification prediction vector;
determining second information entropy according to the second classification prediction vector; and
obtaining the information gain based on a difference between the second information entropy and the first information entropy.

12. The computing system according to claim 11, wherein the trained first graph neural network comprises multiple aggregation layers and an output layer; and the determining the second classification prediction vector of the first unlabeled node based on the trained first graph neural network includes:
performing, at an aggregation layer in the multiple aggregation layers, random zeroing processing on vector elements in multiple aggregation vectors for the multiple nodes that are output by an upper aggregation layer, and determining, based on the multiple aggregation vectors after the random zeroing processing, multiple aggregation vectors that are output by the aggregation layer for the multiple nodes; and
processing, at the output layer, an aggregation vector output by a last aggregation layer for the first unlabeled node, to obtain the second classification prediction vector.

13. The computing system according to claim 11, wherein the trained first graph neural network comprises multiple aggregation layers and an output layer; and the determining the second classification prediction vector of the first unlabeled node based on the trained first graph neural network includes:
performing, at an aggregation layer in the multiple aggregation layers, random zeroing processing on a matrix element in an adjacency matrix corresponding to the relational graph, and determining, based on the adjacency matrix after the random zeroing processing and multiple aggregation vectors that are output by an upper aggregation layer for the multiple nodes, multiple aggregation vectors for the multiple nodes that are output by the aggregation layer; and
processing, at the output layer, an aggregation vector output by a last aggregation layer for the first unlabeled node, to obtain the second classification prediction vector.

14. The computing system according to claim 13, wherein the determining the second classification prediction vector of the unlabeled node based on the trained first graph neural network includes:
performing for multiple times an operation of determining the second classification prediction vector to correspondingly obtain multiple second classification prediction vectors;
wherein the determining the second information entropy according to the second classification prediction vector includes:
determining an average value of multiple pieces of information entropy respectively corresponding to the multiple second classification prediction vectors as the second information entropy.

15. The computing system according to claim 9, wherein the updating the model parameter in the current graph neural network according to the classification prediction vector and the real classification label that are corresponding to each labeled node in the multiple nodes, and the classification prediction vector, the pseudo classification label, and the information gain that are corresponding to each unlabeled node includes:
determining a first loss term according to the classification prediction vector and the real classification label that are corresponding to each labeled node;
determining a second loss term for each unlabeled node according to the classification prediction vector and the pseudo classification label that are corresponding to each unlabeled node, and weighting the second loss term by using the information gain corresponding to the unlabeled node; and
updating the model parameter according to the first loss term and the weighted second loss term.

16. The computing system according to claim 15, wherein the weighting the second loss term by using the information gain corresponding to the unlabeled node includes:
normalizing the information gain of each unlabeled node by using a first quantity of information gains corresponding to the first quantity of unlabeled nodes, to obtain a corresponding weighting coefficient; and
performing weighting processing by using the weighting coefficient.

17. A non-transitory computer readable storage medium that stores computer executable instructions, which when executed by a processor, configure the processor to perform actions comprising:
performing multiple rounds of updating on a graph neural network based on a relational graph, a round of the multiple rounds including:
processing the relational graph by using a current graph neural network, to obtain multiple classification prediction vectors corresponding to multiple nodes in the relational graph;
allocating a corresponding pseudo classification label to a first quantity of unlabeled nodes in the multiple nodes based on the multiple classification prediction vectors;
determining, for each of the first quantity of unlabeled nodes, an information gain generated by training the current graph neural network by using the unlabeled node; and
updating a model parameter in the current graph neural network according to a classification prediction vector and a real classification label that are corresponding to each labeled node in the multiple nodes, and a classification prediction vector, a pseudo classification label, and an information gain that are corresponding to each unlabeled node.

18. The storage medium according to claim 16, wherein the multiple nodes comprise a second quantity of unlabeled nodes, and classification prediction vectors comprise multiple prediction probabilities corresponding to multiple categories;
wherein the allocating the corresponding pseudo classification label to the first quantity of unlabeled nodes in the multiple nodes based on the multiple classification prediction vectors includes:
for each node in the second quantity of unlabeled nodes, in response to that a maximum prediction probability included in a classification prediction vector corresponding to the node reaches a threshold, classifying the node into the first quantity of unlabeled nodes, and determining a category corresponding to the maximum prediction probability as a pseudo classification label of the node.

19. The storage medium according to claim 17, wherein the determining, for each of the first quantity of unlabeled nodes, the information gain generated by training the current graph neural network by using the unlabeled node includes:
for a first unlabeled node of the first quantity of unlabeled nodes,
training the current graph neural network by using a first classification prediction vector and a pseudo classification label that are corresponding to the first unlabeled node, and determining a second classification prediction vector of the first unlabeled node based on a trained first graph neural network;
determining first information entropy according to the first classification prediction vector;
determining second information entropy according to the second classification prediction vector; and
obtaining the information gain based on a difference between the second information entropy and the first information entropy.

20. The storage medium according to claim 19, wherein the trained first graph neural network comprises multiple aggregation layers and an output layer; and the determining the second classification prediction vector of the first unlabeled node based on the trained first graph neural network includes:
performing, at an aggregation layer in the multiple aggregation layers, random zeroing processing on vector elements in multiple aggregation vectors for the multiple nodes that are output by an upper aggregation layer, and determining, based on the multiple aggregation vectors after the random zeroing processing, multiple aggregation vectors that are output by the aggregation layer for the multiple nodes; and
processing, at the output layer, an aggregation vector output by a last aggregation layer for the first unlabeled node, to obtain the second classification prediction vector.
